(19) United States
(12) Patent Application Publication
(10) Pub. No.: US 2025/0005494 A1
(43) Pub. Date: Jan. 2, 2025

(54) AUTOMATED POSITIONING OF INTERNET OF THINGS (IOT) SENSORS IN A WORKSPACE FOR EFFECTIVE PERFORMANCE MONITORING

(71) Applicant: INTERNATIONAL BUSINESS MACHINES CORPORATION, ARMONK, NY (US)

(72) Inventors: Jeremy R. Fox, Georgetown, TX (US); Su Liu, Austin, TX (US); Tushar Agrawal, West Fargo, ND (US); Sarbajit K. Rakshit, Kolkata (IN)

(21) Appl. No.: 18/216,189

(22) Filed: Jun. 29, 2023

(51) Int. Cl. G06Q 10/0639; G06Q 10/0633

(52) U.S. Cl. CPC G06Q 10/06393; G06Q 10/0633

(57) ABSTRACT

A system, method, and computer program product are configured to: analyze historic data of plural activities using machine learning; determine a monitoring boundary for an activity based on the analyzing; determine a type of information for monitoring the activity based on the analyzing; generate a recommendation of a sensor to capture the type of information; and generate a recommendation of a location of the sensor in the monitoring boundary.

### BACKGROUND

Aspects of the present invention relate generally to workflow monitoring and, more particularly, to automated positioning of Internet of Things (IoT) sensors in a workspace to facilitate effective monitoring of key performance indicators (KPIs) of a workflow.

Different types of information are useful to monitor workflow activities in a workspace. Such information can be collected using sensors. The collected information can be used to control processes, generate alerts, and make improvements to the workflow.

### SUMMARY

In a first aspect of the invention, there is a computer-implemented method including: analyzing, by a processor set, historic data of plural activities using machine learning; determining, by the processor set, a monitoring boundary for an activity based on the analyzing; determining, by the processor set, a type of information for monitoring the activity based on the analyzing; generating, by the processor set, a recommendation of a sensor to capture the type of information; and generating, by the processor set, a recommendation of a location of the sensor in the monitoring boundary.

In another aspect of the invention, there is a computer program product including one or more computer readable storage media having program instructions collectively stored on the one or more computer readable storage media. The program instructions are executable to: analyze historic data of plural activities using machine learning; determine a monitoring boundary for an activity based on the analyzing; determine a type of information for monitoring the activity based on the analyzing; generate a recommendation of a sensor to capture the type of information; and generate a recommendation of a location of the sensor in the monitoring boundary.

In another aspect of the invention, there is a system including a processor set, one or more computer readable storage media, and program instructions collectively stored on the one or more computer readable storage media. The program instructions are executable to: analyze historic data of plural activities using machine learning; determine a monitoring boundary for an activity based on the analyzing; determine a type of information for monitoring the activity based on the analyzing; generate a recommendation of a sensor to capture the type of information; and generate a recommendation of a location of the sensor in the monitoring boundary.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a data entity relationship diagram in accordance with aspects of the present invention.

FIG. 5 shows a flowchart of an exemplary method in accordance with aspects of the present invention.

FIG. 6 shows a flowchart of an exemplary method in accordance with aspects of the present invention.

### DETAILED DESCRIPTION

Aspects of the present invention relate generally to workflow monitoring and, more particularly, to automated positioning of Internet of Things (IoT) sensors in a workspace to facilitate effective monitoring of key performance indicators (KPIs) of a workflow. A workflow may comprise one or more activities that are performed in a workspace. Different steps of an activity may have one or more KPIs that are quantifiable indicators of successful performance of the steps. KPIs may be based on detectable parameters, and these parameters may be monitored to determine whether an activity is progressing in accordance with a KPI. For example, different types of sensors may be placed in the workspace to monitor these parameters, and the data collected by these sensors may be monitored and analyzed to determine whether an activity is properly progressing toward completion.

Implementations of the invention are configured to determine types of sensors used to collect data for KPI monitoring, e.g., collecting and analyzing sensor data to determine whether a step/activity/workflow complies with one or more KPIs. Implementations of the invention are further configured to determine optimal spatial positioning of the sensors in the workspace (also called the surrounding) in order to collect the data used in the KPI monitoring. Conventional systems have no way of automatically determining optimal sensor types and spatial positioning of sensors in a workspace. As a result, a large amount of time is spent with trial and error in determining types and locations of sensors. Even then, the positioning of the sensors may be suboptimal, and this suboptimal positioning may not even be known to the personnel responsible for performing the monitoring. Implementations of the invention overcome these problems in conventional systems by using machine learning with historical data to determine optimal sensor types and spatial positioning of sensors in a workspace. As such, implementations of the invention provide a technical improvement in the field of workflow monitoring. In one example, the improvement includes making the monitoring process more efficient by eliminating time spent performing sensor selection and placement using trial and error. In another example the improvement includes making the monitoring more accurate by determining optimal sensor types and locations that might be overlooked when performing sensor selection and placement using trial and error.

In an aspect of the invention, a system, method, and computer program product are configured to generate and/or update a key performance indicator (KPI) ontology monitoring system by: analyzing an activity based on historically learned data to predict activity boundaries in the workspace (e.g., surrounding) to identify the monitoring space of the activity; deploying additional sensors for monitoring in the identified activity space; identifying, using historical learning and current data, relevant and useful information captured for an activity (e.g., pre-activity, in process, or post-activity) that is to be monitored; and recommending, based on the identifying, adjustments and/or updates to the system to better collect the relevant data, the recommendation including the types of sensors required to collect the appropriate kind of data.

In embodiments, the system, method, and computer program product may be further configured to identify the times for the data and/or information capture needs from the surrounding, such as when to start data collection in advance of the activity start how long (e.g., duration) to continue data collection after the activity has been completed; and configure and deploy the sensors in the surrounding for that activity based on the identified duration. In embodiments, the system, method, and computer program product are further configured to: identify the associated workflow to an activity, the steps involved and their correlations; and configure and deploy sensors in the activity surrounding such that the activity workflow can be monitored properly to report against the necessary KPIs for the specific activity. In embodiments, the configuration of and deploying of sensors can capture KPI data for multiple activities being carried out in parallel. In embodiments, the system, method, and computer program product are further configured to identify the KPIs required for different activities and the relative positions of the different activities in surrounding (e.g., including the overlapping spaces).

In this manner, embodiments can be used to identify and deploy the appropriate sensors to optimal locations in the workspace such that an activity can be monitored effectively per a defined policy such as a KPI. In embodiments, the types of sensors used may include but are not limited to: temperature sensors; humidity sensors; light sensors; proximity sensors; motion sensors; accelerometers; gyroscopes; magnetometers; barometers; and location sensors such as global positing system (GPS) sensors. Embodiments may also create an activity monitoring dashboard that dynamically displays sensor data relative to KPIs to provide real-time visual indicators that can be used by personnel monitoring the workflow.

Implementations of the invention are necessarily rooted in computer technology. For example, the step of analyzing historic data of plural activities using machine learning computer-based and cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as sensor deployment code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

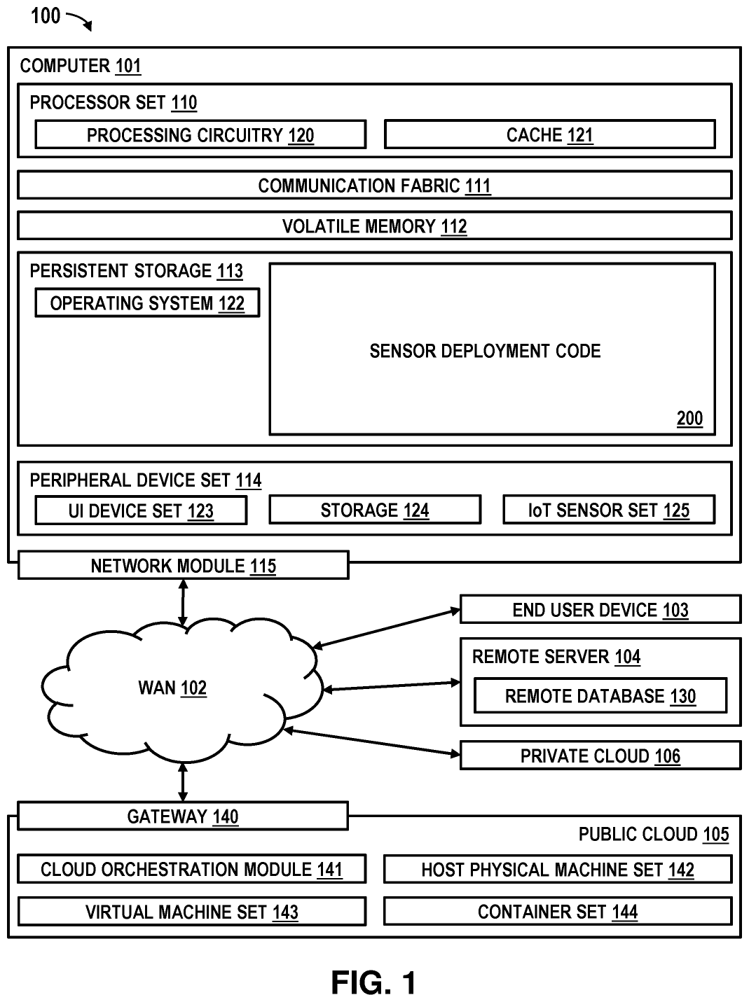

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

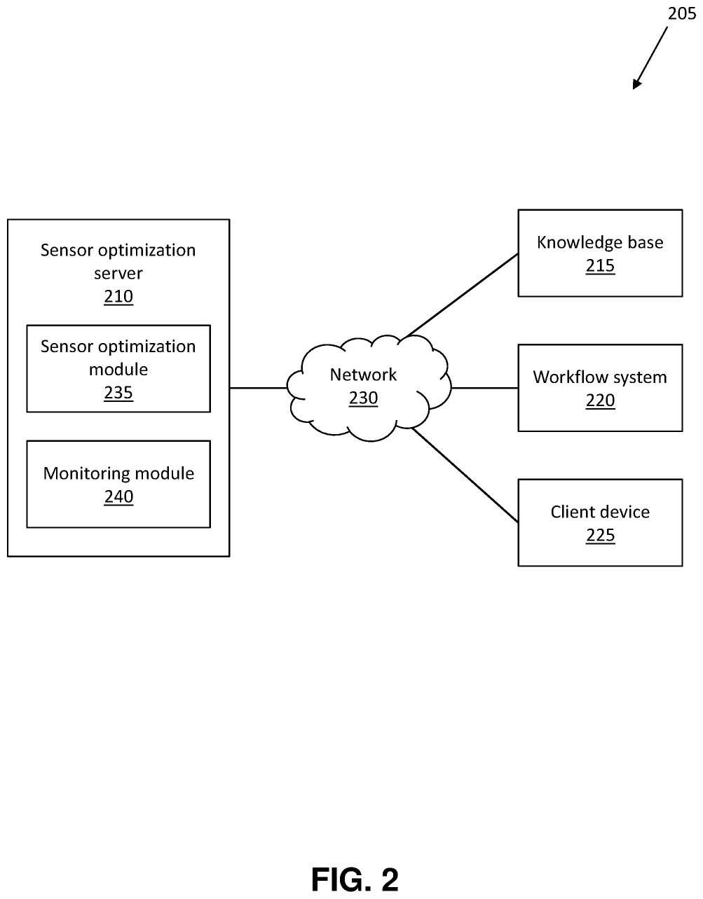

FIG. 2 shows a block diagram of an exemplary environment 205 in accordance with aspects of the invention. In embodiments, the environment 205 includes a sensor optimization server 210 that is configured to perform steps of the inventive methods as described herein. In one example, the sensor optimization server 210 comprises one or more instances of the computer 101 of FIG. 1. In another example, the sensor optimization server 210 comprises one or more virtual machines or containers running on one or more instances of the computer 101 of FIG. 1.

In embodiments, the sensor optimization server 210 communicates with a knowledge base 215, a workflow system 220, and a client device 225 via a network 230. The network 230 may comprise one or more communication networks such as a LAN, WAN, and the Internet. For example, the network 230 may comprise the WAN 102 of FIG. 1.

In embodiments, the client device 225 comprises a computing device that permits a user to interface with the sensor optimization server 210. The client device 225 may comprise one or more instances of the EUD 103 of FIG. 1, for example.

In embodiments, the workflow system 220 comprises a computing device that contains data that defines aspects of a current workflow. The workflow system 220 may comprise one or more instances of remote server 104 of FIG. 1, for example. The aspects of a current workflow defined by the data in the workflow system 220 may include one or more of: activities included in the workflow; steps (or tasks) includes in each activity; one or more KPIs for one or more of the activities and/or steps; and coordinates (e.g., cartesian coordinates) of the workspace and objects within the workspace.

In embodiments, the knowledge base 215 comprises a repository that contains data that defines aspects of historic workflows. The knowledge base 215 may comprise one or more instances of remote database 130 of FIG. 1, for example. The aspects of a historic workflow defined by the data contained in the knowledge base 215 may include one or more of: activities included in the workflow; steps (or tasks) includes in each activity; one or more KPIs for one or more of the activities and/or steps; coordinates (e.g., cartesian coordinates) of the workspace and objects within the workspace; location and type of sensors used in the workspace to collect data for KPI monitoring in the workspace; and times that data is collected from the sensors (e.g., start times and stop times of the data collection relative to the start time and stop time of an activity or step). In embodiments, the knowledge base 215 includes such data for many different workflows of many different types in many different workspaces.

In embodiments, the sensor optimization server 210 of FIG. 2 comprises a sensor optimization module 235 and monitoring module 240, which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The sensor optimization server 210 may include additional or fewer modules than those shown in FIG. 2. In embodiments, separate modules may be integrated into a single module.

Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the sensor optimization module 235 is configured to analyze an activity based on historically learned data to predict activity boundaries in the workspace (e.g., surrounding) to identify the monitoring space of the activity. In embodiments, the sensor optimization module 235 deploys additional sensors for monitoring in the identified activity space.

In accordance with aspects of the invention, the sensor optimization module 235 is configured to use historical learning to identify what kind of information should be captured for an activity (e.g., pre-activity, in process, and/or post-activity) that is being monitored. In embodiments, the sensor optimization module 235 recommends the types of sensors required to collect the appropriate kind of data.

In accordance with aspects of the invention, the sensor optimization module 235 is configured to identify the times for the data and/or information capture needs from the surrounding. This may include when to start data collection in advance of the activity start and how long (e.g., duration) to continue data collection after the activity has been completed. In embodiments, the sensor optimization module 235 configures and deploys the sensors in the surrounding for that activity based on the identified duration.

In accordance with aspects of the invention, the sensor optimization module 235 is configured to identify the associated workflow to an activity, the steps involved, and their correlations. Different steps may require different KPIs to be monitored. In embodiments, the sensor optimization module 235 configures and deploys sensors in the activity surrounding such that the activity workflow can be monitored properly to report against the necessary KPIs.

In accordance with aspects of the invention, the sensor optimization module 235 is configured to be operational for multiple activities being carried out in parallel. In embodiments, the sensor optimization module 235 identifies the KPIs required for different activities and the relative positions of the different activities in the surrounding (e.g., including the overlapping spaces). This analysis may be used to identify the appropriate sensors and deploy them to capture the information in the physical surrounding environment. In embodiments, the sensor optimization module 235 also identifies the synergies between multiple activities in terms of optimizing the usage of sensors and data collected.

In accordance with aspects of the invention, the monitoring module 240 is configured to monitor data collected by the sensors that are deployed in the manner defined by the sensor optimization module 235. In embodiments, the monitoring module 240 collects data from the sensors at times and for durations defined by the sensor optimization module 235. The monitoring module 240 may collect the data from the sensors using conventional or later developed techniques. For example, the sensors may comprise IoT sensors and the monitoring module 240 may collect the data from the sensors via an IoT network. In embodiments, the monitoring module 240 uses the data collected by the sensors to monitor one or more KPIs defined by the sensor optimization module 235. In embodiments, the monitoring module 240 provides alerts to a user interface of the client device 225 when a value of collected sensor data falls outside of predefined acceptable boundaries for a monitored KPI. In embodiments, the monitoring module 240 generates and provides a dashboard to the client device 225. The dashboard may include information such as, but not limited to: real time values of collected data of the sensors; a time window of historic values of collected data of the sensors; labels (e.g., indicia) that identify and/or explain the KPIs; and labels (e.g., indicia) that show predefined acceptable boundaries for the KPIs.

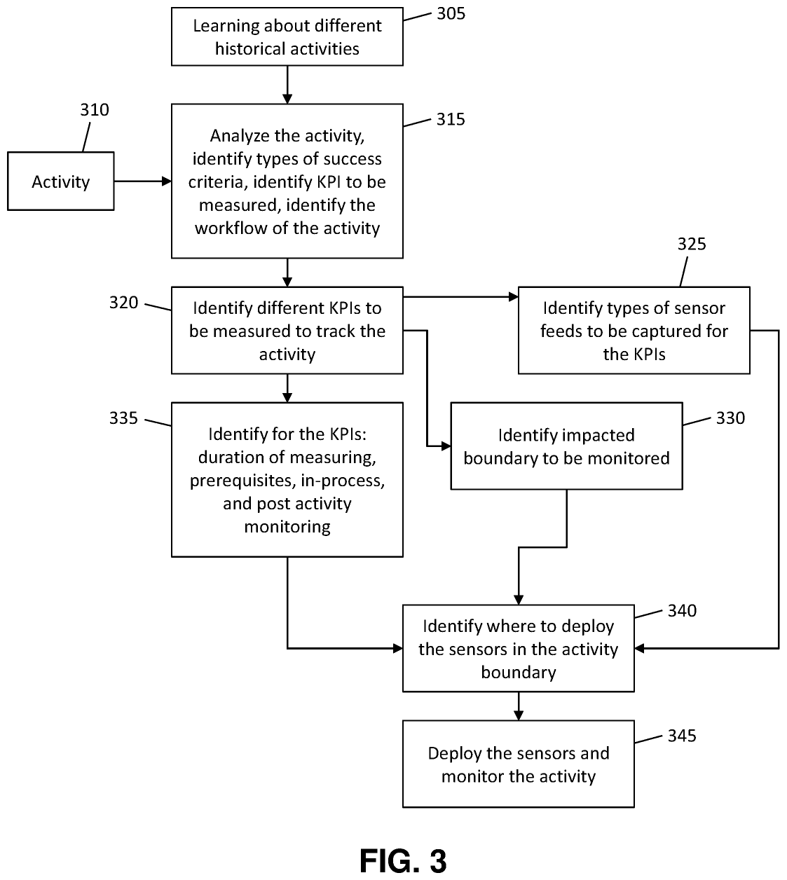

FIG. 3 shows a flowchart of an exemplary method in accordance with aspects of the present invention. Steps of the method may be carried out in the environment of FIG. 2 and are described with reference to elements depicted in FIG. 2. In embodiments, the method shown in FIG. 3 is used to identify which KPIs should be monitored for a workflow to validate or track if activities within the workflow are performed properly. In embodiments, the method is used to identify and deploy sensors for collecting data in identified areas of the workspace.

At block 305, the system learns about different historic activities. In embodiments, the sensor optimization module 235 analyzes the data in the knowledge base 215 using one or more machine learning algorithms to learn (e.g., identify) patterns and or associations in the data. In one example, the sensor optimization module 235 uses a pattern recognition machine learning algorithm to identify patterns in the data. Pattern recognition is the automated recognition of patterns and regularities in data of the knowledge base 215. In one example, the sensor optimization module 235 uses an association rule learning machine learning algorithm to identify associations in the data of the knowledge base 215. Association rule learning is a rule-based machine learning method for discovering relations between variables in large databases. As noted above, data in the knowledge base 215 may define aspects of historic workflows including: activities included in the workflow; steps (or tasks) includes in each activity; one or more KPIs for one or more of the activities and/or steps; coordinates (e.g., cartesian coordinates) of the workspace and objects within the workspace; location and type of sensors used in the workspace to collect data for KPI monitoring in the workspace; and times that data is collected from the sensors. In embodiments, the sensor optimization module 235 analyzes this data to identify patterns and associations in the data that can be used with current activities to predict KPIs for the activity, boundaries, types of data to be collected, locations of sensors in the boundaries to collect the data, and times for collecting the data.

In a non-limiting and illustrative example, the knowledge base 215 may contain data that defines aspects of thousands of different historic workflows each including one or more activities. The sensor optimization module 235 may analyze the data in the knowledge base 215, using machine learning as described above, to identify that the activity of installing a tower is included in a plurality of the historic workflows. The sensor optimization module 235 may analyze the data in the knowledge base 215 associated with these instances of this activity (e.g., installing a tower) to determine patterns and associations in the data associated with this activity, such as tasks included in the activity, physical boundaries of areas in which the tasks are performed, KPIs associated with the activity or tasks, types of data to be collected to monitor the KPIs, locations of sensors in the boundaries to collect the data, and times to collect the data. For example, the sensor optimization module 235 may determine from analyzing the myriad historic data associated with this activity that steps 1-5 are most often included in this activity, that step 1 is most often performed in a boundary having a particular shape and size relative to a particular object (e.g., a crane) in the workspace, that a first KPI is most often associated with step 1, that an accelerometer and a gyroscope are most often used at particular locations in the boundary to collect data that is used in monitoring the first KPI, and relative times that the accelerometer and a gyroscope are used to collect data that is used for monitoring the first KPI. The sensor optimization module 235 may perform this analysis for each of steps 1-5 associated with this activity and store that learned data in a learned knowledge corpus portion of the knowledge base 215. The sensor optimization module 235 may perform a similar analysis for each of plural other activities identified in the historic workflows stored in the knowledge base 215. In this manner, the sensor optimization module 235 learns patterns and associations of aspects of different activities included in historic workflows by using machine learning algorithms to analyze the data in the knowledge base 215.

Still referring to FIG. 3, block 310 represents an activity of a current workflow. Data defining the activity may be stored in the workflow system 220. At block 315, the sensor optimization module 235 analyzes the activity (of block 310) using the learned data, such as patterns and associations of the historic data (from block 305), to determine aspects of the activity to be used for workflow monitoring. The aspects may include, for example, types of success criteria, KPI to be measured, and a workflow of the activity.

At block 320, the sensor optimization module 235 analyzes the activity (of block 310) using the learned patterns and associations of the historic data (from block 305) to identify one or more KPIs to be used to track the activity. For example, based on determining that the activity of block 310 matches the activity of installing a tower described in the example above, the sensor optimization module 235 determines from the learned data for this activity that the first KPI should be used for step 1 of the activity of block 310.

At block 325, the sensor optimization module 235 analyzes the activity (of block 310) using the learned patterns and associations of the historic data (from block 305) to identify what types of information (e.g., sensor feeds) should be captured to derive the KPI identified at block 320. Block 325 may include determining what types of sensors are used to capture the identified information. For example, based on determining that the activity of block 310 matches the activity of installing a tower described in the example above, the sensor optimization module 235 determines from the learned data for this activity that acceleration data and rotational motion data are used for monitoring the first KPI. In this example, the sensor optimization module 235 determines from the learned data that an accelerometer is used to collect the acceleration data and that a gyroscope is used to collect the rotational motion data used for monitoring the first KPI.

At block 330, the sensor optimization module 235 analyzes the activity (of block 310) using the learned patterns and associations of the historic data (from block 305) to identify a boundary to be monitored for this activity. For example, based on determining that the activity of block 310 matches the activity of installing a tower described in the example above, the sensor optimization module 235 determines from the learned data for this activity that step 1 of the activity is most often performed in a boundary having a particular shape and size relative to a particular object (e.g., a crane) in the workspace. Block 330 may include the sensor optimization module 235 determining this boundary having the shape and size in the workspace of the current workflow, i.e., the workflow that includes the activity of block 310. Data defining the workspace of the current workflow, including objects in the workflow (such as a crane in this example) may be obtained from the workflow system 220.

At block 335, the sensor optimization module 235 analyzes the activity (of block 310) using the learned patterns and associations of the historic data (from block 305) to identify times for using the sensors to collect data for performing the KPI monitoring for this activity. For example, based on determining that the activity of block 310 matches the activity of installing a tower described in the example above, the sensor optimization module 235 determines from the learned data for this activity that the accelerometer is used at particular times for a first duration and the gyroscope is used at particular times for a second duration to collect data for monitoring the first KPI. Other parameters associated with when the data is collected may include: prerequisites, in process monitoring, and post activity monitoring, each of which may be inferred by the sensor optimization module 235 for the current activity (of block 310) based on the learned patterns and associations of the historic data (from block 305) for the same type of activity.

At block 340, the sensor optimization module 235 analyzes the activity (of block 310) using the learned patterns and associations of the historic data (from block 305) to identify how the sensors (from block 325) should be deployed in the boundary (from block 330) to monitor the KPI (from block 320. For example, based on determining that the activity of block 310 matches the activity of installing a tower described in the example above, the sensor optimization module 235 determines from the learned data for this activity that the accelerometer should be placed (i.e., physically located) at a first coordinate location in the boundary and that the gyroscope should be placed (i.e., physically located) at a second coordinate location in the boundary.

At block 345, the sensor optimization module 235 deploys the sensors determined at block 325 to the locations determined at block 340. In embodiments, the sensor optimization module 235 transmits instructions to a robotic system that is configured to move instances of the determined sensors to the determined locations within the workspace. Also at block 345, the monitoring module 240 may be used to collect data from the deployed sensors and perform KPI monitoring using this data. For example, the monitoring module 240 may provide alerts and/or a dashboard to the client device 225 using the collected data of the sensors of blocks 325 and 340 and the KPIs of block 320.

Various aspects of the present disclosure are illustrated with the following use cases. In a first use case, Alice is an operations manager who oversees an assembly line at a manufacturing plant. The production line includes a variety of activities that need to be monitored and managed to meet the production goals, thus meeting or exceeding the KPIs generated for that business unit. Alice uses the client device 225 to interface with the sensor optimization server 210 to cause the sensor optimization server 210 to proactively identify and deploy appropriate sensors in the workspace (e.g., the manufacturing plant) such that the activities can be monitored and managed effectively as per the defined policy, e.g., for the stated KPI requirements. In this use case, the sensor optimization server 210 creates an activity monitoring dashboard that dynamically helps Alice identify the relevant positioning of the sensors in the workspace to generate the data required for the stated KPIs. In this use case, the KPIs monitored include assembly line speed, number of defects, and number of products produced as well of quality, quantity, process alignment, and other measurements.

In a second use case, Bob is a warehouse manager who is in charge of managing the inventory in the electronics components warehouse. He needs to monitor the number of electronic products coming in and out of the warehouse, as well as the temperature and humidity of the warehouse for the safety of the products. In this use case, Bob uses the client device 225 to interface with the sensor optimization server 210 to cause the sensor optimization server 210 to proactively identify and deploy the appropriate sensors in the workspace (e.g., the warehouse) to monitor the data required for KPI management (e.g., the number of products coming in and out of the warehouse, as well as the temperature and humidity of the warehouse related to the business objectives). In this use case, the sensor optimization server 210 creates an activity monitoring dashboard that dynamically helps Bob identify the relevant positioning of the sensors in the workspace. In this use case, the KPIs monitored include the number of products coming in and out of the warehouse, temperature, humidity, and any other relevant KPIs. In this use case, the sensor optimization server 210 recommends multiple types of newer sensors on the market to help aid with the KPI monitoring.

In a third use case, functions of the sensor optimization server 210 are used in a retail store to monitor customer activities inside the store. In this use case, the sensor optimization server 210 proactively identifies and deploys the appropriate sensors in the workspace (e.g., the retail store) to monitor customer movements, as well as the temperature, humidity, and lighting of the store. In this use case, the sensor optimization server 210 creates an activity monitoring dashboard that dynamically helps the store staff identify the relevant positioning of the sensors in the workspace and work through the betterment of sensor placement. In this use case, the KPIs monitored include customer traffic, customer purchase rate, temperature, humidity, and lighting. In this use case, all these factors are typed to sales goals and KPI iterative feedback, thus cross-corelating the sensors with objective sales targets for meeting (and exceeding) sales objectives for that particular sales season in that retail store.

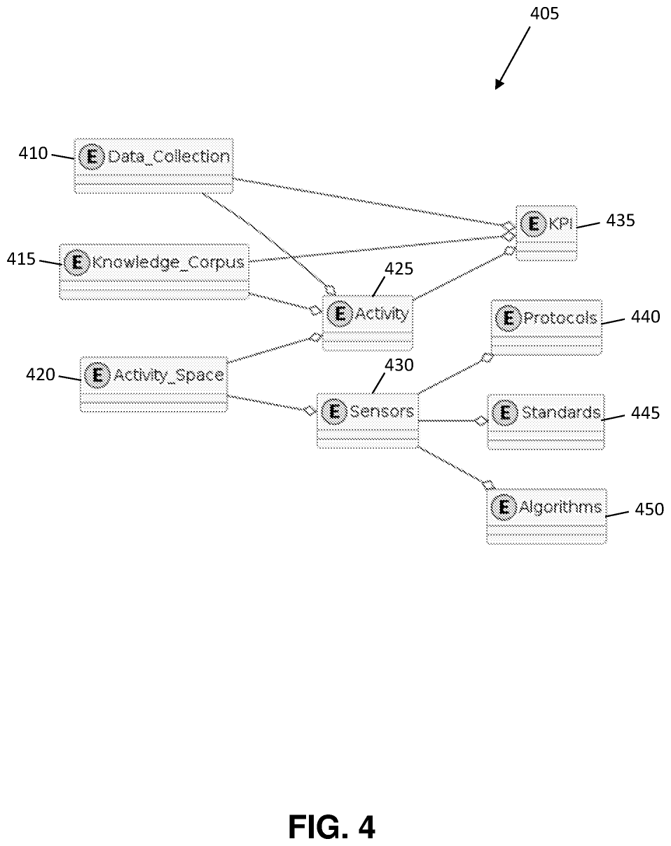

FIG. 4 shows a data entity relationship diagram 405 in accordance with aspects of the present invention. The diagram includes data collection 410, knowledge corpus 415, and activity space 420 in a first group, activity 425 and sensors 430 in a second group, and KPIs 435, protocols 440, standards 445, and algorithms 450 in a third group. As shown in the diagram 405, the data collection 410 is input to the activity 425 and KPIs 435. The knowledge corpus 415 is input to the activity 425 and KPIs 435. The activity space 420 is input to the activity 425 and sensors 430. The activity 425 is input to the KPIs 435. And the sensors 430 data is input to the protocols 440, standards 445, and algorithms 450.

Various aspects of the present disclosure are illustrated in the following description of stages. Embodiments may employ some or all of the following stages in different combinations. Aspects of the stages may be carried out in the environment of FIG. 2 and are described with reference to elements depicted in FIG. 2.

A first stage comprises defining activities and boundaries/space for monitoring KPIs. In this stage, the sensor optimization server 210 identifies the activities that require monitoring. This could range from production processes to warehouse management and customer activity in retail stores, for example. In embodiments, the sensor optimization module 235 identifies the activities based on data obtained from the workflow system 220. In this stage, the sensor optimization server 210 establishes the associated boundaries/space of each activity. This may include the sensor optimization module 235 determining the physical area where the activity is taking place, as well as the key performance indicators that need to be monitored to track the activity. This may be derived from data obtained from the workflow system 220. In this stage, the sensor optimization server 210 groups the activities into categories that can be detected and monitored by a set of IoT devices. For example, manufacturing processes can be monitored using motion sensors, temperature sensors, and pressure sensors, while warehouse management activities can be monitored using temperature sensors, humidity sensors, and light sensors.

A second stage comprises monitoring and identifying activities for the KPIs via iterative looping. In this stage, the sensor optimization server 210 utilizes a set of IoT devices to detect and monitor the activities and their associated boundaries/space. This may involve employing various protocols, standards, and algorithms to detect and monitor the activities. Examples of protocols, standards, and algorithms which can be utilized include Wi-Fi, Bluetooth, and Zigbee. In this stage, the sensor optimization server 210 incorporates KPIs, protocols, standards, and algorithms to detect and monitor the activities. For instance, Wi-Fi can be used to detect and monitor customer activities in a retail store, while Bluetooth can be used to detect and monitor manufacturing processes. Wi-Fi is a wireless networking technology which can be used to detect customer activities in retail stores. Bluetooth is a short-range wireless communication technology which can be used to detect and monitor manufacturing processes. Zigbee is a low-power wireless networking technology which can be used to detect and monitor activities in warehouses. These monitoring types can be utilized for KPIs tracking and infusion into the iterative monitoring process for continuous feedback on the KPI management.

A third stage comprises collecting correlated contexts for KPIs. In this stage, the sensor optimization server 210 obtains correlated contexts associated with the identified activities from a set of IoT sensors. This may include using various technologies, standards, and algorithms to collect the appropriate data from the sensors. Examples of technologies, standards, and algorithms which can be used include LoRa, NB-IoT, and RFID. LoRa is a low-power wide-area network (LPWAN) technology which can be used to collect data from temperature sensors in warehouses. NB-IoT is an LPWAN technology which can be used to collect data from motion sensors in manufacturing processes. RFID (radio-frequency identification) is a technology which can be used to collect data from RFID tags attached to products. In this stage, the sensor optimization server 210 takes advantage of various technologies, standards, and algorithms to collect the necessary data from the sensors. For example, LoRa can be used to collect data from temperature sensors in warehouses, while NB-IoT can be used to collect data from motion sensors in manufacturing processes, for example.

A fourth stage includes analyzing activities based on KPIs based on historically learned data. In this stage, the sensor optimization server 210 analyzes each identified activity based on the historically learned data. This may include using various algorithms to analyze the data and to predict and draw the identified activity boundaries/space in the surrounding according to the predefined and learned data. Examples of algorithms which can be used include machine learning, deep learning, and artificial intelligence. In this stage, the sensor optimization server 210 utilizes various algorithms to analyze the KPIs data and to predict and draw the identified activity boundaries/space in the surrounding according to the predefined and learned data. The algorithms employed can differ depending on the type of activity. For example, machine learning can be used to analyze customer activity in retail stores, while deep learning can be used to predict manufacturing process boundaries/space. Machine learning is a type of artificial intelligence which can be used to analyze customer activity in retail stores, for example. Deep learning is a type of machine learning which can be used to predict manufacturing process boundaries/space, for example. Artificial intelligence is a broad term which can be used to analyze data and predict activity boundaries/space in the surrounding, for example.

A fifth stage includes deploying additional sensors for monitoring related to the KPIs. In this stage, the sensor optimization server 210 deploys additional sensors for monitoring in the identified activity space if the predicted boundary/space of the activity is larger than the monitoring ranges of the associated IoT sensors. This may include using various types of sensors to collect the necessary data for monitoring the activity. Examples of additional sensors which can be deployed include a temperature sensor, humidity sensor, light sensor, proximity sensor, and motion sensor. Temperature sensors can be utilized to monitor the temperature of the surrounding environment. Humidity sensors can be used to monitor the humidity of the surrounding environment. Light sensors can be utilized to detect and monitor the lighting of the surrounding environment. Proximity sensors can be used to detect and monitor the presence of objects in the surrounding environment. Motion sensors can be used to detect and monitor motion in the surrounding environment. All of these types of sensors can have KPIs attached or managed through the ability to infuse the KPI contextual monitoring criteria with iterative feedback looping.

A sixth stage includes configuring sensors for KPIs data collection. In this stage, the sensor optimization server 210 configures the deployed sensors for data collection as per the identified duration. This may include using various protocols, standards, and algorithms to configure the sensors. Examples of protocols, standards, and algorithms which can be used include MQTT. CoAP, and XMPP. The protocols, standards, and algorithms selected can vary depending on the type of activity. For example, MQTT can be used to configure temperature sensors in warehouses, while CoAP can be used to configure motion sensors in manufacturing processes. MQTT is a lightweight messaging protocol which can be used to configure temperature sensors in warehouses, for example. CoAP is a constrained application protocol which can be used to configure motion sensors in manufacturing processes, for example. XMPP is an extensible messaging and presence protocol which can be used to configure light sensors in retail stores, for example.

A seventh stage includes identifying synergies between activities, KPIs, and the user's ecosystem. In this stage, the sensor optimization server 210 identifies the synergies between multiple activities in terms of optimizing the usage of sensors and data collected. This may include using various algorithms to identify the synergies. Examples of algorithms which can be used include Bayesian networks, decision trees, and Markov networks. The sensor optimization server 210 may utilize various algorithms to identify the synergies. The algorithms employed can differ depending on the type of activity. For example, Bayesian networks can be used to identify the synergies between customer activities in retail stores, while decision trees can be used to identify the synergies between manufacturing processes. Bayesian networks are a type of probabilistic graphical models which can be used to identify the synergies between customer activities in retail stores, for example. Decision trees are a type of machine learning algorithm which can be used to identify the synergies between manufacturing processes such as those mentioned in one of the use cases above, for example. Markov networks are a type of graphical model which can be used to identify the synergies between activities in warehouses such as those mentioned in one of the use cases above, for example.

An eighth stage includes establishing a knowledge corpus for KPIs and the management thereof. In this stage, the sensor optimization server 210 establishes a KPI knowledge corpus that is unique to each KPI and its management. This may include using various algorithms to create a knowledge base that is tailored to the KPIs being monitored. Examples of algorithms which can be used include clustering, qualitative infusion, numeric quantitative measurements, etc. The algorithms employed can differ depending on the type of activity. For example, clustering can be used to create a knowledge base for customer activities in retail stores, while natural language processing can be used to create a knowledge base for manufacturing processes. Examples of algorithms which can be used include: clustering, natural language processing, and sentiment analysis. Clustering is a type of unsupervised learning algorithm which can be used to create a knowledge base for customer activities in retail stores, for example. Natural language processing is a type of artificial intelligence which can be used to create a knowledge base for manufacturing processes that might be related to a quality measurement, for example. Sentiment analysis is a type of natural language processing (NLP) which can be used to create a knowledge base for activities in warehouses, for example. In this stage, quantitative KPI measurements can be related to a purely quantitative approach.

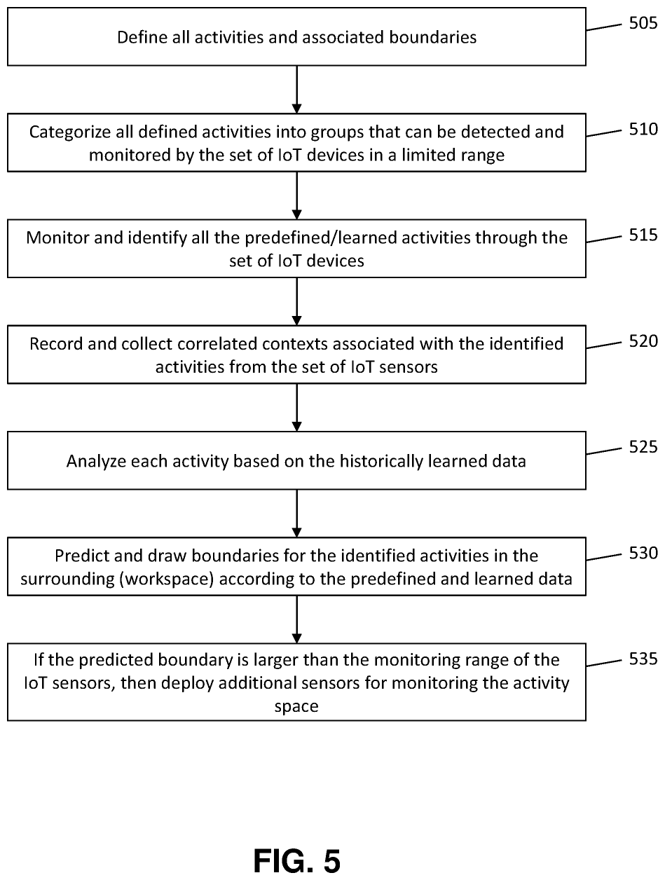

FIG. 5 shows a flowchart of an exemplary method in accordance with aspects of the present invention. Steps of the method may be carried out in the environment of FIG. 2 and are described with reference to elements depicted in FIG. 2.

At step 505, the sensor optimization server 210 defines all activities and associated boundaries for an activity in a workflow. This may be performed using data obtained from the workflow system. At step 510, the sensor optimization server 210 categorizes all defined activities into groups that can be detected and monitored by the set of IoT devices (e.g., IoT sensors) in a limited range. At step 515, the sensor optimization server 210 monitors and identifies all the predefined/learned activities through the set of IoT devices. At step 520, the sensor optimization server 210 records and collects correlated contexts associated with the identified activities from the set of IoT sensors. At step 525, the sensor optimization server 210 analyzes each activity based on the historically learned data. At step 530, the sensor optimization server 210 predicts and draws boundaries for the identified activities in the surrounding (workspace) according to the predefined and learned data. At step 535, if the predicted boundary is larger than the monitoring range of the IoT sensors, then the sensor optimization server 210 deploys additional sensors for monitoring the activity space.

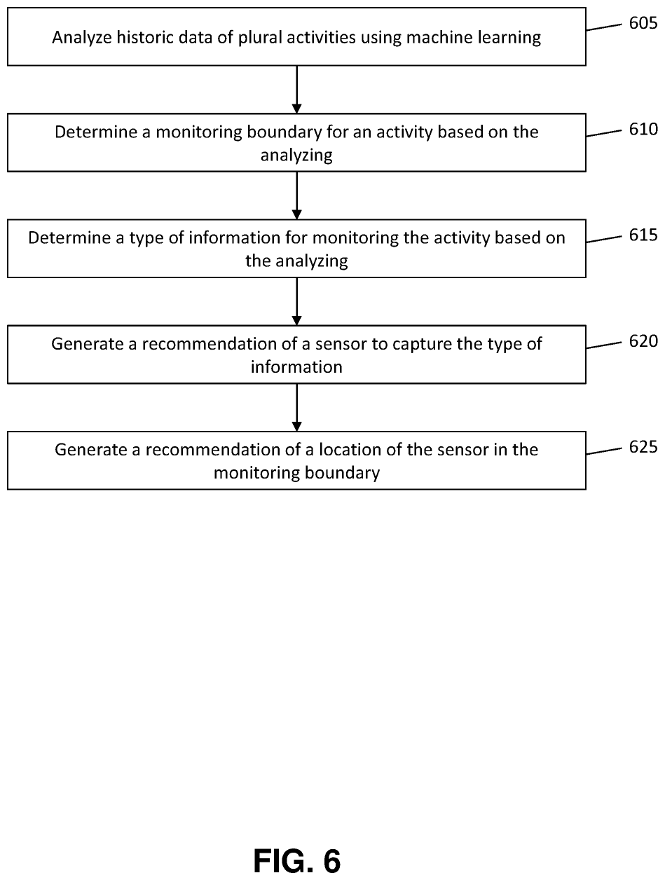

FIG. 6 shows a flowchart of an exemplary method in accordance with aspects of the present invention. Steps of the method may be carried out in the environment of FIG. 2 and are described with reference to elements depicted in FIG. 2.

At step 605, the system analyzes historic data of plural activities using machine learning. In embodiments, and as described with respect to FIG. 2, the sensor optimization module 235 analyzes data in the knowledge base 215 using one or more machine learning algorithms. The analyzing may be used to learn patterns and/or associations in the data regarding historic activities, e.g., as described at block 305 of FIG. 3.

At step 610, the system determines a monitoring boundary for an activity based on the analyzing. In embodiments, and as described with respect to FIG. 2, the sensor optimization module 235 determines a boundary for an activity of a current workflow based on the learned data obtained by analyzing the historic data. In one example, this comprises determining the monitoring boundary based on the learned data that this activity is most often performed in a boundary having a particular shape and size relative to a particular object in the workspace, e.g., as described at block 330 of FIG. 3.

At step 615, the system determines a type of information for monitoring the activity based on the analyzing. In embodiments, and as described with respect to FIG. 2, the sensor optimization module 235 determines from the learned data that one or more types of data are used for monitoring one or more KPIs for this activity, e.g., as described at block 325 of FIG. 3.

At step 620, the system generates a recommendation of a sensor to capture the type of information. In embodiments, and as described with respect to FIG. 2, the sensor optimization module 235 determines from the learned data that a particular type of sensor is used to capture the determined type of information (e.g., a gyroscope is used to capture rotational motion data), e.g., as described at block 330 of FIG. 3. In embodiments, the sensor optimization module 235 generates a recommendation of this sensor via a dashboard or other user interface of the client device 225.

At step 625, the system generates a recommendation of a location of the sensor in the monitoring boundary. In embodiments, and as described with respect to FIG. 2, the sensor optimization module 235 determines from the learned data for this activity that the sensor should be placed (i.e., physically located) at a first coordinate location in the boundary, e.g., as described at block 340 of FIG. 3. In embodiments, the sensor optimization module 235 generates a recommendation of this location via a dashboard or other user interface of the client device 225.

In embodiments, the method includes determining a time to use the sensor to collect the type of information at the location in the monitoring boundary. The time to use the sensor may include: a time to start data collection by the sensor in advance of the activity; and determining a time to stop data collection by the sensor after completion of the activity, e.g., as described at block 335 of FIG. 3.

In embodiments, the method includes deploying the sensor to the location. The sensor may be deployed to the location using a robotic system. In embodiments, the method includes monitoring a key performance indicator of the activity by: collecting data using the deployed sensor; presenting the collected data to a user via a dashboard at a client device. The method may further include determining the key performance indicator of the activity based on the analyzing. e.g., as described at block 320 of FIG. 3.

In embodiments, the method includes: determining the activity comprises a first activity associated with a workflow; determining the workflow comprises a second activity; determining a second monitoring boundary for the second activity; determining a second type of information for monitoring the second activity; generating a recommendation of a second sensor to capture the second type of information; and generating a recommendation of a second location of the second sensor in the second monitoring boundary. In embodiments, and as described with respect to FIG. 2, the sensor optimization module 235 is configured to identify the associated workflow to an activity, the steps involved, and their correlations. Different steps/activities may require different KPIs to be monitored and may have different determined boundaries and types of information used for the respective KPI monitoring.

In embodiments of the method, the activity comprises a first activity in a workflow that comprises plural activities, and the method further comprises: determining at least one respective key performance indicator for each of the plural activities based on the analyzing; determining respective monitoring boundaries for each of the plural activities based on the analyzing; determining respective sensors for collecting respective types of information for monitoring the at least one respective key performance indicator for each of the plural activities based on the analyzing; and deploying the respective sensors to determined locations in the respective monitoring boundaries. In embodiments, and as described with respect to FIG. 2, the sensor optimization module 235 is configured to identify the associated workflow to an activity, the steps involved, and their correlations. Different steps/activities may require different KPIs to be monitored and may have different determined boundaries and types of information used for the respective KPI monitoring.

The method may further comprise determining a first determined location in a first one of the respective monitoring boundaries overlaps a second determined location in a second one of the respective monitoring boundaries at a common location, wherein the deploying the respective sensors to determined locations in the respective monitoring boundaries comprises deploying a single sensor to the common location. In embodiments, and as described with respect to FIG. 2, the sensor optimization module 235 is configured to be operational for multiple activities being carried out in parallel. In embodiments, the sensor optimization module 235 identifies the KPIs required for different activities and the relative positions of the different activities in the surrounding (e.g., including the overlapping spaces). This analysis may be used to identify the appropriate sensors and deploy them to capture the information in the physical surrounding environment. In embodiments, the sensor optimization module 235 also identifies the synergies between multiple activities in terms of optimizing the usage of sensors and data collected.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
analyzing, by a processor set, historic data of plural activities using machine learning;
determining, by the processor set, a monitoring boundary for an activity based on the analyzing;
determining, by the processor set, a type of information for monitoring the activity based on the analyzing;
generating, by the processor set, a recommendation of a sensor to capture the type of information; and
generating, by the processor set, a recommendation of a location of the sensor in the monitoring boundary.

2. The computer-implemented method of claim 1, further comprising determining a time to use the sensor to collect the type of information at the location in the monitoring boundary.

3. The computer-implemented method of claim 2, wherein the determining the time to use the sensor comprises:
determining a time to start data collection by the sensor in advance of the activity; and
determining a time to stop data collection by the sensor after completion of the activity.

4. The computer-implemented method of claim 1, further comprising deploying the sensor to the location in the monitoring boundary.

5. The computer-implemented method of claim 4, wherein the sensor is deployed to the location in the monitoring boundary using a robotic system.

6. The computer-implemented method of claim 4, further comprising monitoring a key performance indicator of the activity by:
collecting data using the sensor;
presenting the collected data to a user via a dashboard at a client device.

7. The computer-implemented method of claim 6, further comprising determining the key performance indicator of the activity based on the analyzing.

8. The computer-implemented method of claim 1, further comprising:
determining the activity comprises a first activity associated with a workflow;
determining the workflow comprises a second activity;
determining a second monitoring boundary for the second activity;
determining a second type of information for monitoring the second activity;
generating a recommendation of a second sensor to capture the second type of information; and
generating a recommendation of a second location of the second sensor in the second monitoring boundary.

9. The computer-implemented method of claim 1, wherein the activity comprises a first activity in a workflow that comprises plural activities, and further comprising:
determining at least one respective key performance indicator for each of the plural activities based on the analyzing;
determining respective monitoring boundaries for each of the plural activities based on the analyzing;
determining respective sensors for collecting respective types of information for monitoring the at least one respective key performance indicator for each of the plural activities based on the analyzing; and
deploying the respective sensors to determined locations in the respective monitoring boundaries.

10. The computer-implemented method of claim 9, further comprising determining a first determined location in a first one of the respective monitoring boundaries overlaps a second determined location in a second one of the respective monitoring boundaries at a common location, wherein the deploying the respective sensors to determined locations in the respective monitoring boundaries comprises deploying a single sensor to the common location.

11. A computer program product comprising one or more computer readable storage media having program instructions collectively stored on the one or more computer readable storage media, the program instructions executable to:
analyze historic data of plural activities using machine learning;
determine a monitoring boundary for an activity based on the analyzing;
determine a type of information for monitoring the activity based on the analyzing;
generate a recommendation of a sensor to capture the type of information; and
generate a recommendation of a location of the sensor in the monitoring boundary.

12. The computer program product of claim 11, wherein the program instructions are executable to determine a time to use the sensor to collect the type of information at the location in the monitoring boundary, the time to use the sensor comprising a time to start data collection by the sensor in advance of the activity and a time to stop data collection by the sensor after completion of the activity.

13. The computer program product of claim 11, wherein the program instructions are executable to deploy the sensor to the location.

14. The computer program product of claim 11, wherein the program instructions are executable to:
determine a key performance indicator of the activity; and
monitor the key performance indicator using data collected by the sensor.

15. The computer program product of claim 14, wherein the program instructions are executable to:
create a dashboard that displays data about the monitoring the key performance indicator; and
provide the dashboard to a client device.

16. A system comprising:
a processor set, one or more computer readable storage media, and program instructions collectively stored on the one or more computer readable storage media, the program instructions executable to:
analyze historic data of plural activities using machine learning;
determine a monitoring boundary for an activity based on the analyzing;
determine a type of information for monitoring the activity based on the analyzing;
generate a recommendation of a sensor to capture the type of information; and
generate a recommendation of a location of the sensor in the monitoring boundary.

17. The system of claim 16, wherein the program instructions are executable to determine a time to use the sensor to collect the type of information at the location in the monitoring boundary, the time to use the sensor comprising a time to start data collection by the sensor in advance of the activity and a time to stop data collection by the sensor after completion of the activity.

18. The system of claim 16, wherein the program instructions are executable to deploy the sensor to the location.

19. The system of claim 16, wherein the program instructions are executable to:
determine a key performance indicator of the activity; and
monitor the key performance indicator using data collected by the sensor.

20. The system of claim 19, wherein the program instructions are executable to:
create a dashboard that displays data about the monitoring the key performance indicator; and
provide the dashboard to a client device.
